(19) United States
(12) Patent Application Publication
(10) Pub. No.: US 2003/0179738 A1
(43) Pub. Date: Sep. 25, 2003

(54) Wireless communications apparatus, methods and computer program products using broadcast control channel messaging

(76) Inventors: John Diachina, Garner, NC (US); Hans Carlsson, Cary, NC (US)

Correspondence Address: MYERS BIGEL SIBLEY & SAJOVEC, PO BOX 37428, RALEIGH, NC, 27627, US

(21) Appl. No.: 10/090,688

(22) Filed: Mar. 5, 2002

(51) Int. Cl. H04J 3/24; H04L 12/66

(52) U.S. Cl. 370/349; 370/352

(57) ABSTRACT

First, second and third classes of Packet System Information (PSI) messages are transmitted on a Packet Broadcast Control Channel (PBCCH) of a General Packet Radio Service (GPRS) wireless mobile packet data communications system at respective first, second and third repetition rates. The PSI messages of the third class may comprise Extremely Low Repetition (ELR) Payload messages including embedded information from an application layer, such as a Location Services (LCS) application layer. In some embodiments, a scheduling message may additionally be transmitted on the PBCCH to indicates a schedule for transmission for the PSI messages of the third class.

### BACKGROUND OF THE INVENTION

The present invention relates to wireless communications apparatus, methods and computer program products, and more particularly, to apparatus, methods and computer program products for communicating messages in a wireless communications system.

There is an ever-present demand for new types of services in wireless communications systems, such as the GSM-based General Packet Radio System (GPRS). As such systems have evolved to provide new services, the volume of information communicated to terminals has generally increased. For example, a number of different location (or “location-based”) services (LCS) are now being offered or contemplated by a wireless system operators. Such services may provide information to wireless terminals for use in location estimation processes, such as assistance or correction information for use in Enhanced Observed Time Difference (E-OTD) or Global Positioning System (GPS) location estimation methods, as described in the Third Generation Partnership (3GPP) technical report Broadcast Network Assistance for Enhanced Observed Time Difference (E-OTD) and Global Positioning System (GPS) Positioning Methods, Technical Report 3GPP TS 04.35 V8.4.0 (2001-12), 3GPP (2001). It is generally desirable that such information be provided in a timely and bandwidth-efficient manner.

### SUMMARY OF THE INVENTION

According to some embodiments of the present invention, first, second and third classes of Packet System Information (PSI) messages are transmitted on a Packet Broadcast Control Channel (PBCCH) of a General Packet Radio Service (GPRS) wireless mobile packet data communications system at respective first, second and third repetition rates. For example, successive portions of the sequence of messages of the second class may be transmitted in successive intervals between repeated transmissions of the sequence of messages of the first class, and a message of a third class may be transmitted once per an integer multiple transmissions of the sequence of messages of the second class. The PSI messages of the third class may comprise Extremely Low Repetition (ELR) Payload messages including embedded information from an application layer, such as a Location Services (LCS) application layer. In some embodiments, a scheduling message may additionally be transmitted on the PBCCH to indicate a schedule for transmission for messages of the third class.

According to further embodiments of the present invention, in a wireless communications system that repetitively transmits system information messages on a broadcast control channel, messages that contain embedded information from application layer messages are transmitted at a lower repetition rate than that at which the system information messages are transmitted on the broadcast control channel. The messages that contain embedded information from application layer messages may comprise an identifying portion formatted consistent with the system information messages and a payload portion including information from an application layer message.

The present invention may be embodied as apparatus, such as base stations, wireless terminals, circuit modules, and Application Specific Integrated Circuits (ASICs). The present invention may also be embodied as methods and computer program products.

### BRIEF DESCRIPTION OF THE DRAWINGS

FIG. 1 illustrates exemplary timing relationships among broadcast messages according to some embodiments of the present invention.

FIG. 2 illustrates exemplary timing relationships among broadcast messages according to further embodiments of the present invention.

FIG. 3 illustrates wireless apparatus and operations according to some embodiments of the present invention.

FIG. 4 illustrates a wireless terminal and exemplary operations thereof according to further embodiments of the present invention.

### DETAILED DESCRIPTION

The present invention will now be described more fully with reference to the accompanying drawings, in which typical embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

According to embodiments of the present invention, wireless mobile packet data communications systems, methods and computer program products may be provided. Many of the embodiments of the present invention described herein relate to provision of Extremely Low Repetition (ELR) broadcast control messages on a Packet Broadcast Control Channel (PBCCH) of a General Packet Radio Service (GPRS) system, but it will be appreciated that the present invention is applicable to other types of wireless communications systems.

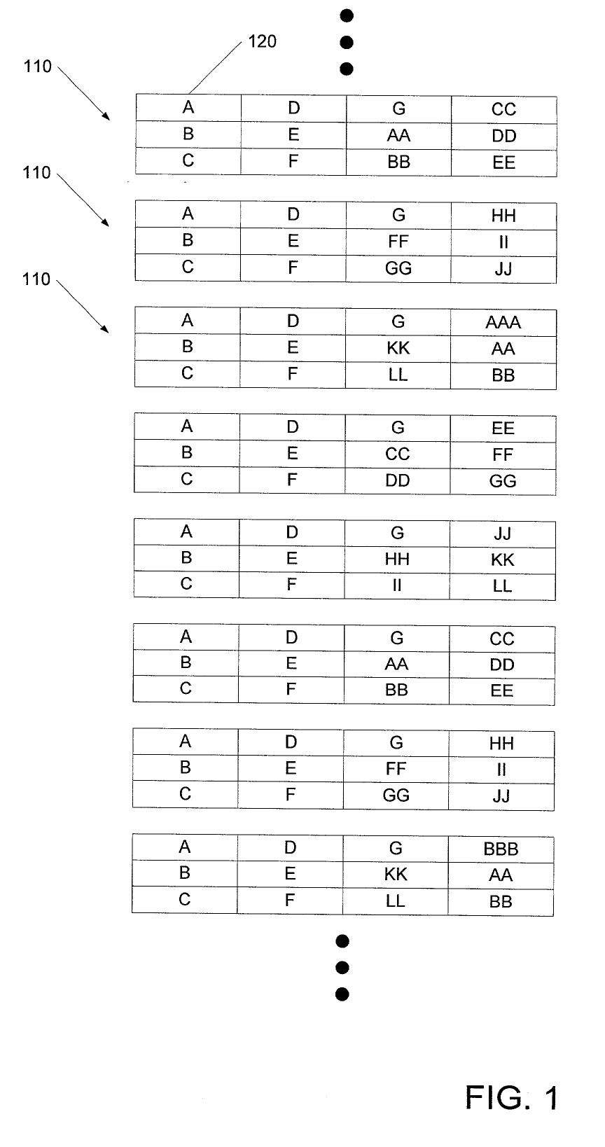

In the present application, FIGS. 1-4 are diagrams illustrating exemplary apparatus and operations according to embodiments of the present invention. It will be understood that operations depicted in the diagrams, and combinations thereof, may be implemented using one or more electronic circuits, such as a circuits included in a component of a wireless communications system or in a wireless terminal. It will also be appreciated that, in general, operations depicted in the diagrams, and combinations thereof, may be implemented in one or more electronic circuits, such as in one or more discrete electronic components, one or more integrated circuits (ICs) and/or one or more application specific integrated circuits (ASICs) and/or application specific circuit modules, as well as by computer program instructions which may be executed by a computer or other data processing apparatus, such as a microprocessor or digital signal processor (DSP), to produce a machine such that the instructions which execute on the computer or other programmable data processing apparatus create electronic circuits or other means that implement the specified operations. The computer program instructions may also be executed on one or more computers or other data processing apparatus to cause a series of actions to be performed by the computer(s) or other programmable apparatus to produce a computer implemented process that includes the specified operations.

The computer program instructions may also be embodied in the form of a computer program product in a computer-readable storage medium, i.e., as computer-readable program code embodied in the medium for use by or in connection with an instruction execution system. The computer-readable storage medium may include, but is not limited to, electronic, magnetic, optical or other storage media, such as a magnetic or optical disk or an integrated circuit memory device. For example, the computer program instructions may be embodied in memory included in a component of a wireless communications apparatus and/or storage medium operable to program such memory. Accordingly, blocks of the schematic diagrams of FIGS. 1-4 support electronic circuits and other apparatus that perform the specified operations, acts for performing the specified operations, and computer program products configured to perform the specified operations.

In a conventional GPRS system, messages broadcast on the Packet Broadcast Control Channel (PBCCH) are called Packet System Information (PSI) messages. Conventional GPRS systems support two target repetition rates for PSI messages—High Repetition (HR) and Low Repetition (LR). It is generally a configuration option of the system to determine which particular PSI messages will be sent as HR messages and which ones will be sent as LR messages, i.e., other than a few exceptions, the GPRS standard does not prescribe which messages should be sent as HR messages and which ones should be sent as LR messages. In some conventional GPRS systems, the GPRS LR data rate is about 75 bits/sec and the existing GPRS HR data rate is about 150 bits/sec.

One problem with existing LR PSI messages is that they may contain information needing significantly different repetition intervals. For example, a complete set of Neighbour List information (carried within a PSI3 message and within multiple instances of a PSI3bis message) needs to be sent quite often, but not as often as HR information. Thus, the repetition requirements for PSI3 and PSI3bis messages push the LR repeat period to be as small as possible (e.g., a few seconds), whereas other LR PSI messages may actually need to be sent far less often. In conventional systems, the LR repeat period is typically established so that it satisfies the most demanding of the LR PSI messages, causing some PSI messages to get transmitted far more often than is actually necessary. Information broadcast to terminals for LCS applications may only need to be sent at rates that are much lower than the conventional LR repetition rate.

The CBCH (Cell Broadcast Channel) can be used to send the broadcast information required to support an LCS application layer in GSM/GPRS. However, because the real time occurrence of CBCH information may actually overlap with the real time occurrence of paging information on the Packet Common Control Channel (PCCCH) for any given mobile terminal, less than optimal system performance may result.

According to some embodiments of the invention, an Extremely Low Repetition (ELR) broadcast control channel message may be provided, appropriate for supporting the broadcast of information that requires a relatively low bandwidth, e.g., as low as 5 bits/sec. According to further embodiments, such an ELR broadcast control channel message may comprise an ELR Payload message that serves as a transport mechanism for a higher-level application, such as an LCS application layer.

ELR broadcast control channel messages need not be limited to the same repetition rules currently in effect for HR or LR PSI messages, as they can be transmitted according to a set of transmission rules different from existing HR and LR PSI message transmission rules. A potential advantage that can be provided by such messages is improved efficiency of broadcast bandwidth utilization. For example, a GPRS system may be configured according to embodiments of the present invention to provide a full set of HR PSI messages every 1.2 seconds, a full set of LR PSI messages sent every 2.4 seconds and a full set of ELR broadcast control channel messages sent every 240 seconds.

According to another aspect of the present invention, an ELR Schedule message may be provided that allows a mobile terminal to know in advance when any particular higher layer message will be sent using an ELR Payload message. This can be particularly advantageous in applications in which a higher layer message of interest to a mobile terminal is sent infrequently, as the ELR Schedule message can provide timing information that allows the mobile terminal to “wake up” to read an ELR Payload message of interest and then return to a power-conserving sleep mode. This can result in reduced battery power consumption and other benefits.

In the conventional GPRS specification, a full sequence of LR PSI messages can be repeated starting at each occurrence of FN=0, where FN is the TDMA frame number. FN is cyclic and ranges from 0 to FN_MAX where FN_MAX=(26×51×2048)-1=2,715,647 (as defined in GSM 05.10), and is incremented at the end of each TDMA frame. The complete cycle of TDMA frame numbers from 0 to FN_MAX is defined as a hyperframe. A hyperframe consists of 2048 superframes, where a superframe is defined as 26×51 TDMA frames. A TDMA frame is comprised of 8 time slots and has a duration of 4.62 (60/13) ms. The time period associated with a single hyperframe is 3 hours and 28 minutes after which the FN cycle repeats.

In current practice, a full set of LR PSI messages is sent with a periodicity determined by the most time critical messages in the set. As such, a full set of LR PSI messages is typically sent every few seconds, even though some LR PSI messages could be sent far less often. This practically results in the least time critical LR PSI messages effectively being limited to the periodicity demands of the most time critical LR PSI messages. A potential result of the existing rules for LR PSI message transmission is bandwidth inefficiency, a problem that can become even more pronounced whenever new low transmission rate broadcast information is added to packet system operation to support new services.

According to some GPRS embodiments of the present invention, to support the transmission of extremely low rate broadcast information using a PBCCH, the existing PSI concepts of HR PSI messages and LR PSI messages can be supplemented with a new class of PBCCH messages, i.e., Extremely Low Repetition (ELR) PSI messages. According to some embodiments, such ELR PSI messages comprise ELR Payload messages that can be used as a transport medium for higher level application layer messages, such as application layer messages for Location Services such as E-OTD and GPS assistance. According to further embodiments, an ELR Schedule message may also be sent on the PBCCH. This message can include an indication of when a ELR Payload message will be sent so that, for example, a mobile terminal can awake at an appropriate time to receive the ELR Payload message, and then return to sleep mode to thereby conserve battery power.

According to further GPRS embodiments, an ELR Payload message is similar to conventional PSI messages, in that it has an identifying portion comprising an opening octet that has a message type to identify the message. An ELR Payload message may further delimit the starting octet and the ending octet of application layer messages embedded therein, thereby allowing a mobile terminal to determine the contiguous set of octets comprising a single application layer message.

According to further aspects, multiple ELR Payload messages may be used to send a single application layer message. ELR Payload messages may also have a format that allows one application layer message to end and another to begin within any given ELR Payload message. This can provide greater bandwidth efficiency, as an ELR Payload message need not be padded with filler octets whenever an application layer message ends at some point within the message, i.e., the next application layer message can begin in the octet immediately following the last octet of the current application layer message. An ELR Payload message may also provide an explicit indication that supports the case where a new application layer message is started following the last octet of the current application layer message, as there may not be any additional application layer message requiring transmission upon sending the last octet of the current application layer message. An ELR Payload message may further include a sequence number (e.g., modulo 256) to allow a mobile terminal to determine the correct sequence of incoming ELR Payload messages and thereby be able to extract a complete set of application layer messages. All messages belonging to the application layer may be octet aligned, such that the transport service offered by ELR Payload messages is not required to perform bit padding on an application layer message to achieve an integral number of octets.

In further embodiments of the present invention, ELR broadcast control channel messages, such as the ELR Payload messages discussed above, may be sent with a specific periodicity that a mobile terminal can determine either explicitly, e.g., by reading a broadcast control channel message content that provides this information, or implicitly, e.g., by determining the spacing between consecutive ELR broadcast control channel messages. Where ELR broadcast control channel message periodicity is determined implicitly, it may be desirable to provide a broadcast message that indicates that ELR broadcast control channel messages are supported in the serving cell. This can allow a mobile terminal to know whether it should keep reading broadcast information until it finds an ELR broadcast control channel message.

Examples of periodicity for ELR Payload messages in an exemplary GPRS LCS application according to some embodiments of the present invention are as follows:

2 ELR Payload messages sent in each LR cycle (most frequent case)
1 ELR Payload message sent in each LR cycle
1 ELR Payload message sent every 2 LR cycles
1 ELR Payload message sent every 5 LR cycles
1 ELR Payload message sent every 10 LR cycles
1 ELR Payload message sent every 20 LR cycles (least frequent case)
An exemplary ELR Payload message format for such an LCS application is as

follows:

| Octet 1 = Message Type (6 bits) + Page Mode (2 bits) | |
|---|---|
| > | Message Type - coded using a code point not used by existing |
| | PSI messages. |
| > | Page Mode — coded exactly as per existing PSI messages. |
| Octet 2 = Sequence Number (8 bits) | |
| > | Sequence Number — a modulo 255 counter that is |

decremented by 1 for every instance of ELR Payload message
sent. The counter starts with the value of the highest numbered
sequence of all the ELR Payload messages and counts down to
zero. It is coded to indicate where any given ELR Payload
message fits in the overall sequence of ELR Payload messages.
Particular sequence numbers may be reserved for special
messaging purposes, such as for an ELR Schedule message.

Octet 3 = End of Message (EOM) Indicator (5 bits) + New Message
Available (NMA) Indicator (1 bit) + Protocol Discriminator (2 bits)

| | |
|---|---|
| > | EOM Indicator — coded as follows: |

| | |
|---|---|
| 00000 = | Current application layer message has ended |
| | (check NMA Indicator to see if a new |
| | application layer begins in octet 4) |
| 00001 = | Current application layer message ends in octet |
| | 4 (check NMA Indicator to see if a new |
| | application layer begins in octet 5) |
| 00010 = | Current application layer message ends in octet |
| | 5 (check NMA Indicator to see if a new |
| | application layer begins in octet 6) |
| 10011 = | Current application layer message ends in octet |
| | 22 (check NMA Indicator to see if a new |
| | application layer begins in octet 23) |
| ...10100 = | Current application layer message ends in octet |
| | 23 |
| 10101 = | Current application layer message is continued |
| | in the next ELR-Payload message |
| 10110... | 11111 = Spare |

| | |
|---|---|
| > | NMA Indicator — coded as follows: |

| | |
|---|---|
| 0 = | A new application layer message does not begin |
| | in this ELR Payload message |
| 1 = | A new application layer message begins in this |
| | ELR Payload message after the octet indicated |
| | by EOM Indicator |

| | |
|---|---|
| > | Protocol Discriminator — identifies the application layer |
| | protocol for which payload information is provided and is |
| | coded as follows: |

| | |
|---|---|
| 00 — | LCS (an existing application layer) |
| 01, 10 and 11 | —Reserved (for future application layers) |

Octets 4-23 = Application layer Payload (N octets) + Filler (20 - N

octets)

| | |
|---|---|
| > | Application layer Payload — coded per application layer |
| | message content where 0 ≦ N ≦ 20. |
| > | Filler—each one of these octets is coded as Elhex. |

According to further aspects of the present invention, ELR Payload messages may be exempt from and/or have no effect on change marking rules implemented with respect to PSI messages in some conventional GPRS systems. In some conventional systems, after a mobile terminal has acquired a full set of broadcast information on the PBCCH, it is typically not required to keep reading all PBCCH information continually.

Instead, a rule may be followed by which a mobile terminal is required to read a PSI1 message at least once every 30 seconds. In a conventional PSI1 message, there is an information element (IE) called PBCCH_CHANGE_MARK, which is essentially a 3-bit counter. Every time there is a change in the information broadcast on the PBCCH, the counter is stepped by one. This allows a mobile terminal that is monitoring PSI1 messages once every 30 seconds to detect any change of PBCCH information. A mobile terminal that detects a change that is more than a single level typically is required to reacquire all broadcast information. A lesser step change may only require reading of a subset of the broadcast information.

According to embodiments of the present invention, some ELR Payload messages, such as those carrying E-OTD assistance data, may change frequently, e.g., once every 30 seconds or so. Consequently, a general rule that says that for any change of PSI message content, the PBCCH_CHANGE_MARK is stepped, may be undesirable in the case of ELR Payload messages. Accordingly, it may be preferable that ELR Payload messages not follow the regular change marking rules, and that generation of a change mark IE should not be influenced by ELR Payload messages.

According to further GPRS embodiments of the present invention, ELR Schedule messages may be also provided in conjunction with ELR Payload messages on the PBCCH. These messages may include an indication of when transmission of a ELR Payload message occurs, such that a receiving mobile terminal can wake at an appropriate time to receive an ELR Payload message, and thereby conserve battery power. In some embodiments, an ELR Schedule message is similar to conventional PSI messages in that it has an opening octet that has a message type to identify the message. The ELR Schedule message can optionally provide a mobile terminal with an indication of a multi-frame in which a specific higher layer message begins. This can effectively be accomplished by including the sequence number of the ELR Payload message that contains at least the beginning portion of the higher layer message of interest. Once the mobile terminal has determined the periodicity of ELR Payload messages and the sequence number of the most recently received ELR Payload message, it can determine the multi-frame in which to begin reading the higher layer message of interest.

In further embodiments, if ELR Schedule messages are supported in cell, they preferably are included in at least the 52-multi-frame for which an ELR Payload message having a Sequence Number=0 is sent. If sent more often, they may be placed in any other 52-multi-frame containing an ELR Payload message. Upon reading an ELR Payload message with Sequence Number=0, a mobile terminal can read the next ELR Payload message (having the same Protocol Discriminator value) to determine the total number of ELR Payload messages being used to convey the full set of higher layer messages associated with a given application layer (determined by the Protocol Discriminator value). For the case where scheduling information cannot fit within a single instance of an ELR-Schedule message, additional instances of this message may be sent up to a predetermined maximum number of instances (e.g., four).

An exemplary ELR Schedule message format for a GPRS LCS application according to some embodiments of the present invention is as follows:

| Octet 1 = Message Type (6 bits) + Page Mode (2 bits) | |
|---|---|
| > | Message Type - coded using a code point not used by existing |
| | PSI messages. |
| > | Page Mode — coded exactly as per existing PSI messages. |
| Octet 2 = Index (2 bits) + Count (2 bits) + Protocol Discriminator (2 | |
| bits) + Spare (2 bits) | |
| > | Index — identifies the instance of ELR-Schedule message |
| | being sent and coded as follows: |
| | 00 - instance 1 of the ELR-Schedule message |
| | 01 - instance 2 of the ELR-Schedule message |
| | 10 - instance 3 of the ELR-Schedule message |
| | 11 - instance 4 of the ELR-Schedule message |
| > | Count - identifies the total number of ELR-Schedule messages |
| | comprising a full set and is coded as follows: |
| | 00 - 1 ELR-Schedule message sent in total |
| | 01 - 2 ELR-Schedule messages sent in total |
| | 10 - 3 ELR-Schedule messages sent in total |
| | 11 - 4 ELR-Schedule messages sent in total |
| > | Protocol Discriminator - identifies the application layer |
| | protocol for which payload information is provided and is |
| | coded as follows: |
| | 00 - LCS (an existing application layer) |
| | 01, 10 and 11 - Reserved (for future application layers) |
| > | Spare — coded as 00 |
| Octets 3-5 = Application Message Type (16 bits) + Payload Sequence | |
| Number (8 bits) | |
| > | Application Message Type — the length of this field is based |
| | on the application indicated by the Protocol Discriminator field |
| | provided in octet 2 above. For Protocol Discriminator = 00 |
| | (LCS) this field is 16 bits long and is coded according to the 16 |
| | bit message types defined for the actual LCS application. |
| > | Payload Sequence Number — identifies the Sequence Number |
| | of LCS-Payload message that contains at least the beginning |
| | portion of the higher layer message identified by the |
| | Application Message Type field. It is coded as per the |
| | Sequence Number field contained in the header of an ELR- |
| | Payload message. A Payload Sequence Number = 11111111 |
| | indicates that no scheduling information is being provided by |
| | this field. |

Octets 6-8=same as octets 3-5
Octets 9-11 = same as octets 3-5
Octets 12-14 = same as octets 3-5
Octets 15-17 = same as octets 3-5
Octets 18-20 = same as octets 3-5
Octets 21-23 = same as octets 3-5

An exemplary GPRS LCS implementation is as follows:

| PSII_REPEAT)PERIOD = 5 | |
|---|---|
| BS_PBCCH_BLKS=4 | |
| The set of HR and LR messages supported is such that a full set of PSI | |
| LR messages is sent within 10 multi-frames (2.4 seconds) | |
| A total of 128 ELR Payload messages are used to convey a full set of | |
| application layer messages (i.e. the first ELR Payload message in a full | |
| set of these messages has Sequence Number = 0111 1111 and the last | |
| one has a Sequence Number = 0000 0000). | |
| The periodicity of ELR Payload messages is acquired implicitly by a | |
| mobile terminal, i.e., by noting the interval between any 2 successive | |
| ELR Payload messages, and is determined to be 10 LR cycles. | |
| An ELR Schedule message is received in a multi-frame where an ELR | |
| Payload message is present and whose Sequence Number = 00. It | |
| provides information about the scheduling of a single application layer | |
| message in octets 3 to 5: | |
| > | Only 1 ELR-Schedule message is needed, so Index = 00 and |
| | Count = 00 |
| > | Protocol Discriminator is coded as “00” to indicate LCS is the |
| | application layer protocol supported. |
| > | Application Message Type is coded as “xxxxxxxx xxxxxxxx” |
| | indicating a specific LCS Application layer message. |
| > | Payload Sequence Number is coded as “0110 0100” which |
| | indicates that the specific application message indicated by |
| | Application Message Type begins in the ELR-Payload message |
| | with Sequence Number = 100, i.e. the indicated Application |
| | layer message begins in 27 × (10 × 10) = 2700 multiframes = |
| | 2700 × 0.24 = 648 seconds. |

Rules for transmission of PSI messages in such an implementation are summarized in Table I:

TABLE I

| | Transmission | |
|---|---|---|
| Message | Requirement | Transmission Conditions |
| PSI 1 | Required | Sent in B0 when TC = 0 |
| | | Sent in B6 when TC = 0 i the value of |
| | | the parameter BS_PBCCH_BLKS is greater |
| | | than 1 |
| HR | Option | Sent in a sequence determined by the network |
| | | Sent starting at TC = 0, using the PBCCH |
| | | blocks within each 52-multiframe, in the order |
| | | of their occurrence, which are not occupied by |
| | | PSI 1 |
| | | The full sequence of LR PSI messages |
| | | shall be repeated starting at each occurrence |
| | | of TC = 0 |
| LR | Optional | Sent in a sequence determined by the network |
| | | These messages are continuously repeated, |
| | | using the PBCCH blocks within each 52-multi- |
| | | frame, in the order of their occurrence, |
| | | which are not occupied by PSI 1 or HR PSI |
| | | messages |
| | | The full sequence of LR PSI messages shall be |
| | | repeated starting at each occurrence of FN = 0 |
| ELR | Option | Sent in a fixed sequence by the network |
| | | When sent, these messages occupy PBCCH slot |
| | | normally used to send LR PSI messages. They |
| | | are included following the last LR PSI message |
| | | in a cycle of LR PSI messages and as such they |
| | | of the next cycle of LR PSI messages by a few |
| | | PBCCH will delay the start blocks. The net |
| | | result is that the nominal period for a full |
| | | cycle of LR PSI messages will be the same |
| | | but will slip every time an ELR-Payload or |
| | | ELR-Schedule message is sent. |

FIG. 1 illustrates respective matrices 110 of broadcast message transmission opportunities 120 in respective instances of a plurality of sets of GPRS 52-multiframes (each column of each matrix represents a single 52-multiframe) for conventional PSI messages and ELR broadcast messages (e.g., ELR payload messages for transporting information from higher application layer messages) according to some embodiments of the present invention. A sequence of HR PSI messages A, B, . . . , F, G is repeatedly transmitted, with portions of a sequence of LR messages AA, BB, . . . , KK, LL being transmitted in intervals between transmissions of the HR PSI message sequence A, B, C, . . . , F, G. For example, assuming that each matrix 110 represents a one second time interval, the first sequence A, B, . . . , F, G is transmitted at a rate of one time per second, while the second sequence AA, BB, . . . , KK, LL is transmitted at a rate slightly higher than one time every three seconds.

According to the illustrated embodiments, a sequence of ELR broadcast messages AAA, BBB, . . . may be transmitted such that one ELR broadcast message is transmitted for every third cycle of transmission of the LR sequence AA, BB, . . . KK, LL. In particular, an ELR message may be transmitted in the transmission window immediately following transmission of a final message LL of the LR message sequence AA, BB, . . . , KK, LL.

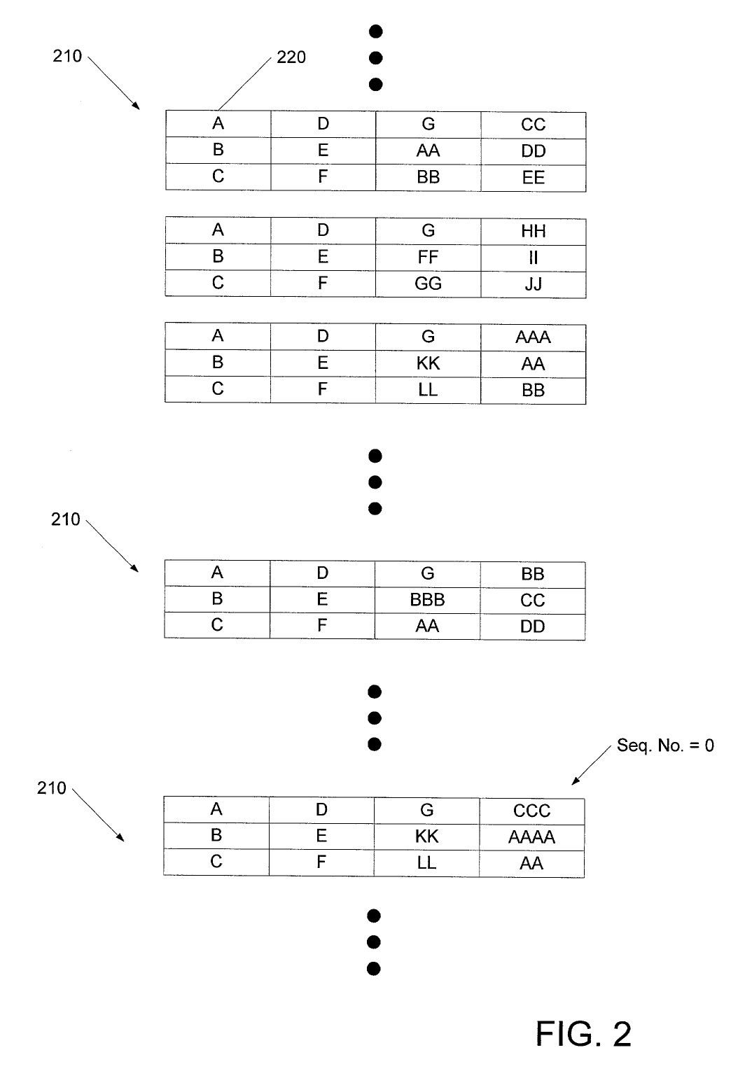

FIG. 2 illustrates respective matrices 210 of broadcast message transmission opportunities 220 in respective instances of a plurality of sets of GPRS 52-multiframes for conventional PSI messages, ELR broadcast messages (e.g., ELR payload messages for transporting information from higher application layer messages) and ELR broadcast scheduling messages according to some embodiments of the present invention. As with the embodiments of FIG. 1, a sequence of HR PSI messages A, B, . . . , F, G is repeatedly transmitted, with portions of a sequence of LR messages AA, BB, . . . , KK, LL being transmitted in intervals between transmissions of the HR PSI message sequence A, B. C, . . . , F, G.

According to the embodiments of FIG. 2, a sequence of ELR broadcast messages AAA, BBB, CCC may be transmitted such that one ELR broadcast message is transmitted for every third cycle of transmission of the LR sequence AA, BB, . . . KK, LL, i.e., immediately following transmission of a final message LL of the LR message sequence AA, BB, . . . , KK, LL. In addition, an ELR broadcast scheduling message AAAA is transmitted immediately following the last (e.g., sequence number=0) ELR broadcast message CCC.

It will be appreciated that the embodiments of FIGS. 1 and 2 are provided for purposes of illustration, and that the present invention is not limited to such embodiments. For example, the number of messages, periodicity and relative time positions of the message sequences shown in FIGS. 1 and 2 may be varied within the scope of the present invention.

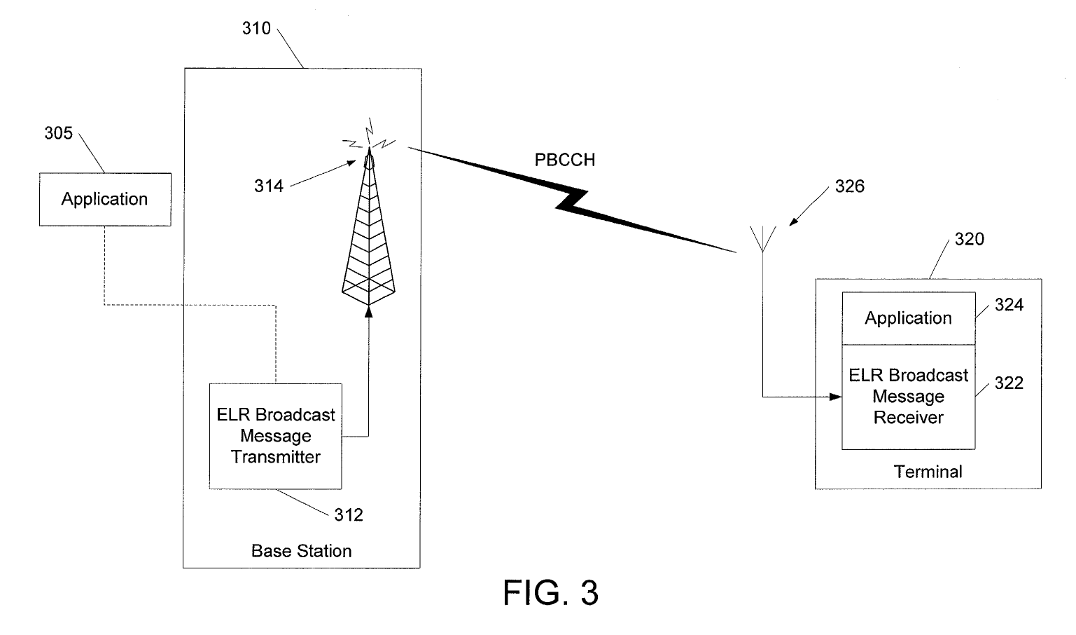

FIG. 3 illustrates a base station 310 and wireless terminal 320 that implement a LCS application according to embodiments of the present invention. The base station 310 includes an Extremely Low Repetition (ELR) broadcast message transmitter 312 that receives application layer messages from an application layer 305 and embeds information from the received application layer messages in ELR broadcast messages transmitted from a base station antenna 314 over a Packet Broadcast Control Channel (PBCCH). It will be appreciated that the application layer 305 may be co-located with the transmitter 312, e.g., at a base station site, or may be resident elsewhere in the wireless communication system of which the base station 310 is a node. It will be appreciated that the transmitter 312 may include a processor, such as a microprocessor or microcontroller, along with associated memory, that is operative to execute program code that cause transmission of ELR messages. As described above, the ELR broadcast control messages transmitted by the base station 310 may be accompanied by ELR broadcast scheduling messages.

The transmitted ELR broadcast control messages are received over the PBCCH by a complementary ELR broadcast control message receiver 322 of the terminal 320 via an antenna 326. The ELR broadcast message receiver 322 conveys application layer messages embedded in the received ELR broadcast messages to an application layer 324, for example, an application program that perform E-OTD or GPS computations. It will be appreciated that, according to some embodiments of the present invention, the transmitter 312 and/or the receiver 322 may comprise re-configured (e.g., reprogrammed) conventional GPRS transmitters and receivers that provide ELR broadcast message functionality of the present invention, along with conventional broadcast control channel messaging functions, e.g., transmission and reception of conventional Packet System Information (PSI) messages.

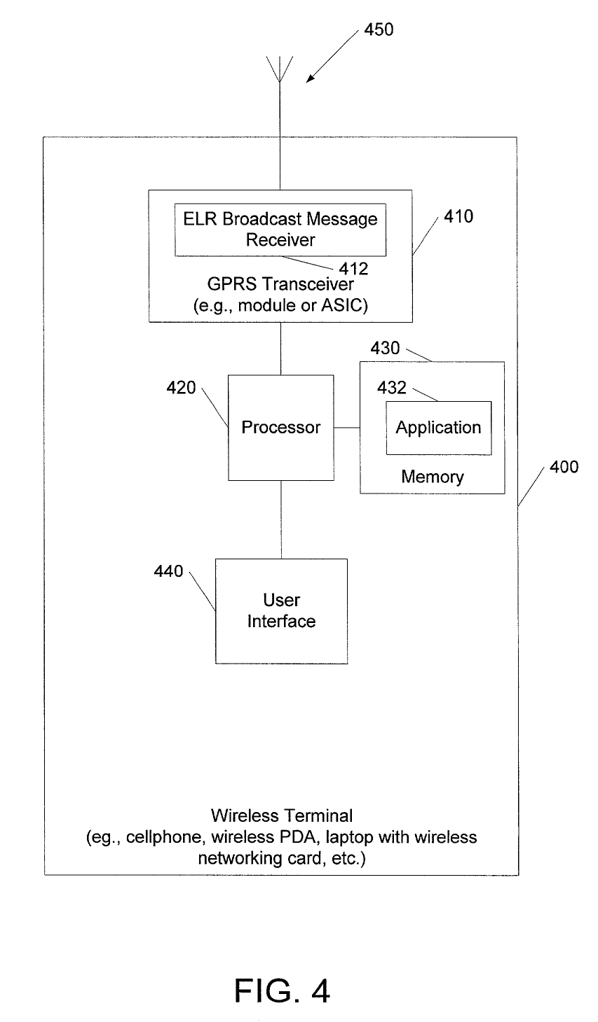

FIG. 4 illustrates a wireless terminal 400 that supports ELR broadcast messaging according to embodiments of the present invention. The terminal 400 may include, but is not limited to, a cellular telephone, wireless personal digital assistant (PDA), laptop computer with a wireless networking card, or other electronic device capable of wireless communication. The terminal 400 includes a GPRS receiver 410, which may take the form, for example, of an application specific integrated circuit (ASIC) or circuit module, that is operative to receive radio signals via an antenna 450. The terminal 400 also includes a processor 420, such as a microprocessor, microcontroller, or digital signal processor (DSP). The processor 420 may be operatively associated with, among other things, a memory 430 (e.g., DRAM, EEPROM or the like) and a user interface 440, which may include, for example, a keyboard and display. The processor 420 may be operative to execute an application 432, such as a E-OTD or GPS application, that is resident in the memory 430.

The GPRS receiver 410 includes an ELR broadcast message receiver 412. The ELR broadcast message receiver 412 is operative to receive ELR broadcast messages (and, optionally, ELR broadcast scheduling messages) over a PBCCH. The ELR broadcast message receiver 412 may be operative to convey application layer messages embedded in the received ELR payload messages to the application 432. It will be appreciated that the receiver 412 may include a processor and associated memory that executes program code for receiving ELR messages, and that all or some of these functions may be performed by the processor 420 and memory 430.

It will appreciated that the present invention may be implemented as methods, including, but not limited to, methods of operating a wireless mobile packet data communications system, methods of operating a wireless base station, and methods of operating a wireless terminal. It also will be understood that the present invention may be embodied in apparatus, including, but not limited to, wireless packet data communications systems, wireless base stations, wireless terminals, modules for use in wireless base stations and/or terminals, and ASICs for use in wireless base station and/or wireless terminals. It will be further appreciated that the present invention may be embodied as computer program products configured to be executed in an apparatus such as a wireless base station or a wireless terminal, such that apparatus and/or acts according to the invention may be provided.

In the drawings and specification, there have been disclosed typical embodiments of the invention and, although specific terms are employed, they are used in a generic and descriptive sense only and not for purposes of limitation, the scope of the invention being set forth in the following claims.

That which is claimed:

1. A method of operating a General Packet Radio Service (GPRS) wireless mobile packet data communications system, the method comprising:
transmitting first, second and third classes of Packet System Information (PSI) messages on a Packet Broadcast Control Channel (PBCCH) at respective first, second and third repetition rates.

2. A method according to claim 1, wherein transmitting first, second and third classes of PSI messages on a Packet Broadcast Control Channel (PBCCH) at respective first, second and third repetition rates comprises:
periodically transmitting a sequence of messages of the first class;
transmitting successive portions of the sequence of messages of the second class in successive intervals between transmissions of the sequence of messages of the first class; and
transmitting a message of a third class once per an integer multiple of transmissions of the sequence of messages of the second class.

3. A method according to claim 2, wherein transmitting a message of a third class once per an integer multiple of transmissions of the sequence of messages of the second class comprises transmitting a message of the third class following transmission of a final message of the sequence of messages of the second class.

4. A method according to claim 1, wherein the PSI messages of the third class comprise Extremely Low Repetition (ELR) Payload messages including embedded information from an application layer message.

5. A method according to claim 4, further comprising embedding a first portion of an application layer message in a first ELR Payload message and embedding a second portion of the application layer message in a second ELR Payload message.

6. A method according to claim 4, further comprising embedding information from first and second application layer messages in a single ELR Payload message.

7. A method according to claim 6, further comprising including an indicator of the presence of information from multiple application layer messages in the single ELR Payload message.

8. A method according to claim 1, further comprising transmitting a schedule message on the PBCCH that indicates a schedule for transmission for messages of the third class.

9. A method according to claim 8, wherein the PSI messages of the third class comprises ELR Payload messages comprising embedded information from application layer messages, and wherein transmitting a schedule message that indicates a schedule for transmission of messages of the third class comprises transmitting an ELR Schedule message that indicates when an ELR Payload message including information from an application layer message of interest will be transmitted.

10. A method of operating a wireless packet data communications system that repetitively transmits system information messages on a broadcast control channel, the method comprising:
transmitting messages on the broadcast control channel that contain embedded information from application layer messages at a lower repetition rate than that at which the system information messages are transmitted on the broadcast control channel.

11. A method according to claim 10, wherein the messages that contain embedded information from application layer messages comprise an identifying portion formatted consistent with the system information messages and a payload portion including information from an application layer message.

12. A method according to claim 10, wherein the system information messages comprise a first class of system information messages transmitted at a first repetition rate and a second class of system information messages transmitted at a second repetition rate that is less than the first repetition rate, and wherein transmitting messages on the broadcast control channel that contain embedded information from application layer messages at a lower repetition rate than that at which the system information messages are transmitted on the broadcast control channel comprises transmitting the messages that contain embedded information from application layer messages at a third repetition rate that is less than the second repetition rate.

13. A method according to claim 12, wherein transmitting the messages that contain information from application layer messages at a third repetition rate that is less than the second repetition rate comprises transmitting one message that contains information from an application layer message per an integer multiple of transmissions of the sequence of system information messages of the second class.

14. A method according to claim 13, wherein transmitting one message that contains embedded information from an application layer message per an integer multiple of transmissions of the sequence of system information messages of the second class comprises transmitting a message that contains embedded information from an application layer message following transmission of a final message of the sequence of system information messages of the second class.

15. A method according to claim 10, wherein transmitting messages on the broadcast control channel that contain embedded information from application layer messages at a lower repetition rate than that at which the system information messages are transmitted comprises transmitting first and second messages on the broadcast control channel that contain embedded information from a single application layer message.

16. A method according to claim 10, wherein transmitting messages on the broadcast control channel that contain embedded information from application layer messages at a lower repetition rate than that at which the system information messages are transmitted comprises transmitting a single message on the broadcast control channel that contains embedded information from first and second application layer messages.

17. A method according to claim 16, further comprising including an indicator of the presence of information from multiple application layer messages in the single message.

18. A method according to claim 10, further comprising transmitting a schedule message that indicates a schedule for transmission of the messages that contain embedded information from application layer messages.

19. A method according to claim 18, wherein transmitting a schedule message that indicates a schedule for transmission of the messages that contain embedded information from application layer messages comprises transmitting a schedule message that indicates when a message including information from an application layer message of interest will be transmitted.

20. A method of operating a GPRS wireless mobile packet data communications system, the method comprising:
using payload messages multiplexed with Packet System Information (PSI) messages transmitted on a Packet Broadcast Control Channel (PBCCH) as transport layer messages for an application.

21. A method according to claim 20, wherein using payload messages multiplexed with Packet System Information (PSI) messages transmitted on a Packet Broadcast Control Channel (PBCCH) as transport layer messages for an application comprises transmitting the payload messages used as transport layer messages at a rate that is less than the transmission rate of Low Repetition (LR) PSI messages on the PBCCH.

22. A method according to claim 21, wherein transmitting the payload messages used as transport layer messages at a rate that is less than the transmission rate of Low Repetition (LR) PSI messages on the PBCCH comprises transmitting one message used as a transport layer message per an integer multiple cycles of transmission of the LR PSI messages.

23. A method according to claim 20, wherein the application comprises a Location Services (LCS) application.

24. A method of operating a GPRS wireless mobile packet data communications system, the method comprising:
transmitting one Extremely Low Repetition (ELR) Packet System Information (PSI) message on a Packet Broadcast Control Channel (PBCCH) per an integer multiple cycles of transmission of Low Repetition (LR) PSI messages, such that an ELR PSI message is transmitted following transmission of a final LR PSI message of a repeatedly transmitted sequence of LR PSI messages.

25. A method according to claim 24, wherein the ELR PSI messages are used as transport layer messages for an application.

26. A method according to claim 25, wherein the application comprises a Location Services (LCS) application.

27. A method of operating a General Packet Radio Service (GPRS) wireless terminal, the method comprising:
receiving first, second and third classes of Packet System Information (PSI) messages on a Packet Broadcast Control Channel (PBCCH) at respective first, second and third repetition rates.

28. A method according to claim 27, wherein receiving first, second and third classes of Packet System Information (PSI) messages on a Packet Broadcast Control Channel (PBCCH) at respective first, second and third repetition rates comprises receiving a message of a third class once per an integer multiple of transmissions of the sequence of messages of the second class.

29. A method according to claim 28, wherein receiving a message of a third class once per an integer multiple of transmissions of the sequence of messages of the second class comprises receiving a message of the third class following transmission of a final message of the sequence of messages of the second class.

30. A method according to claim 27, wherein the PSI messages of the third class comprise Extremely Low Repetition (ELR) Payload messages including embedded information from an application layer message.

31. A method according to claim 27, further comprising receiving a schedule message on the PBCCH that indicates a schedule for reception of messages of the third class.

32. A method according to claim 31, wherein the PSI messages of the third class comprises ELR Payload messages comprising embedded information from application layer messages, and wherein receiving a schedule message that indicates a schedule for reception of messages of the third class comprises receiving an ELR Schedule message that indicates when an ELR Payload message including information from an application layer message of interest can be received.

33. A method of operating a wireless terminal in a wireless packet data communications system that repetitively transmits system information messages on a broadcast control channel, the method comprising:
receiving messages on the broadcast control channel that contain embedded information from application layer messages at a lower repetition rate than that at which the system information messages are transmitted on the broadcast control channel.

34. A method according to claim 33, wherein the messages that contain embedded information from application layer messages comprise an identifying portion formatted consistent with the system information messages and a payload portion including information from an application layer message.

35. A method according to claim 33, wherein the system information messages comprise a first class of system information messages transmitted at a first repetition rate and a second class of system information messages transmitted at a second repetition rate that is less than the first repetition rate, and wherein receiving messages on the broadcast control channel that contain embedded information from application layer messages at a lower repetition rate than that at which the system information messages are transmitted on the broadcast control channel comprises receiving the messages that contain embedded information from application layer messages at a third repetition rate that is less than the second repetition rate.

36. A method according to claim 35, wherein receiving the messages that contain information from application layer messages at a third repetition rate that is less than the second repetition rate comprises receiving one message that contains information from an application layer message per an integer multiple of transmissions of the sequence of system information messages of the second class.

37. A method according to claim 36, wherein receiving one message that contains embedded information from an application layer message per an integer multiple receptions of the sequence of system information messages of the second class comprises receiving a message that contains embedded information from an application layer message following transmission of a final message of the sequence of system information messages of the second class.

38. A method according to claim 33, further comprising receiving a schedule message that indicates a schedule for reception of the messages that contain embedded information from application layer messages.

39. A method according to claim 38, wherein receiving a schedule message that indicates a schedule for reception of the messages that contain embedded information from application layer messages comprises receiving a schedule message that indicates when a message including information from an application layer message of interest will be transmitted.

40. A base station of a General Packet Radio Service (GPRS) system, the base station comprising:
a transmitter operative to transmit first, second and third classes of Packet System Information (PSI) messages on a Packet Broadcast Control Channel (PBCCH) at respective first, second and third repetition rates.

41. A base station according to claim 40, wherein the transmitter is operative to periodically transmit a sequence of messages of the first class, to transmit successive portions of the sequence of messages of the second class in successive intervals between transmissions of the sequence of messages of the first class, and to transmit a message of a third class once per an integer multiple of transmissions of the sequence of messages of the second class.

42. A base station according to claim 41, wherein the transmitter is operative to transmit a message of the third class following transmission of a final message of the sequence of messages of the second class.

43. A base station according to claim 40, wherein the PSI messages of the third class comprise Extremely Low Repetition (ELR) Payload messages including embedded information from an application layer message.

44. A base station according to claim 40, wherein the transmitter is further operative to transmit a schedule message on the PBCCH that indicates a schedule for transmission for messages of the third class.

45. A base station for a wireless packet data communications system, the base station comprising:
a transmitter operative to repetitively transmit system information messages on a broadcast control channel and to transmit messages on the broadcast control channel that contain embedded information from application layer messages at a lower repetition rate than that at which the system information messages are transmitted on the broadcast control channel.

46. A base station according to claim 45, wherein the messages that contain embedded information from application layer messages comprise an identifying portion formatted consistent with the system information messages and a payload portion including information from an application layer message.

47. A base station according to claim 45, wherein the transmitter is further operative to transmit a schedule message that indicates a schedule for transmission of the messages that contain embedded information from application layer messages.

48. A General Packet Radio Service (GPRS) wireless terminal, comprising:
a receiver operative to receive first, second and third classes of Packet System Information (PSI) messages transmitted on a Packet Broadcast Control Channel (PBCCH) at respective first, second and third repetition rates.

49. A terminal according to claim 48, wherein the receiver is operative to receive a message of a third class that is transmitted once per an integer multiple of transmissions of the sequence of messages of the second class.

50. A terminal according to claim 49, wherein the receiver is operative to receive a message of the third class that is transmitted following transmission of a final message of the sequence of messages of the second class.

51. A terminal according to claim 48, wherein the PSI messages of the third class comprise Extremely Low Repetition (ELR) Payload messages including embedded information from an application layer message.

52. A terminal according to claim 48, wherein the receiver is operative to receive a schedule message on the PBCCH that indicates a schedule for reception of messages of the third class.

53. A terminal according to claim 52, wherein the PSI messages of the third class comprises ELR Payload messages comprising embedded information from application layer messages, and wherein the receiver is operative to receive an ELR Schedule message that indicates when an ELR Payload message including information from an application layer message of interest can be received.

54. A wireless terminal for use in a wireless packet data communications system that repetitively transmits system information messages on a broadcast control channel, the method comprising:
a receiver operative to receive messages on the broadcast control channel that contain embedded information from application layer messages at a lower repetition rate than that at which the system information messages are transmitted on the broadcast control channel.

55. A terminal according to claim 54, wherein the messages that contain embedded information from application layer messages comprise an identifying portion formatted consistent with the system information messages and a payload portion including information from an application layer message.

56. A terminal according to claim 54, wherein the system information messages comprise a first class of system information messages transmitted at a first repetition rate and a second class of system information messages transmitted at a second repetition rate that is less than the first repetition rate, and wherein the terminal is operative to receive the messages that contain embedded information from application layer messages at a third repetition rate that is less than the second repetition rate.

57. A terminal according to claim 54, wherein the receiver is operative to receive a schedule message that indicates a schedule for reception of the messages that contain embedded information from application layer messages.

58. A terminal according to claim 57, wherein the receiver is operative to receive a schedule message that indicates when a message including information from an application layer message of interest will be transmitted.

59. An apparatus, comprising:
means for creating Packet System Information (PSI) messages; and
means for causing periodic transmission of a sequence of Packet System Information (PSI) messages of a first class on a Packet Broadcast Control Channel (PBCCH) of a General Packet Radio Service (GPRS) wireless mobile data communications system, for causing transmission of successive portions of a sequence of PSI messages of a second class on the PBCCH in successive intervals between transmissions of the sequence of PSI messages of the first class, and for causing transmission of a PSI message of a third class on the PBCCH once per an integer multiple of transmissions of the sequence of PSI messages of the second class.

60. An apparatus according to claim 59, wherein the PSI messages of the third class comprise Extremely Low Repetition (ELR) Payload messages including embedded information from an application layer message.

61. An apparatus according to claim 59, further comprising means for creating a schedule message that indicates a schedule for transmission for PSI messages of the third class, and for causing transmission of the schedule message on the PBCCH.

62. An apparatus according to claim 59, wherein the means for creating Packet System Information (PSI) messages and the means for causing periodic transmission of a sequence of Packet System Information (PSI) messages of a first class on a Packet Broadcast Control Channel (PBCCH) of a General Packet Radio Service (GPRS) wireless mobile data communications system, for causing transmission of successive portions of a sequence of PSI messages of a second class on the PBCCH in successive intervals between transmissions of the sequence of PSI messages of the first class, and for causing transmission of a PSI message of a third class on the PBCCH once per an integer multiple of transmissions of the sequence of PSI messages of the second class comprises at least one of an Application Specific Integrated Circuit (ASIC) and a circuit module.

63. An apparatus, comprising:
means for creating system information messages and causing the system information messages to be repetitively transmitted on a broadcast control channel of a wireless packet data communications system; and
means for creating messages that contain embedded information from application layer messages and causing the messages that contain embedded information from application layer messages to be transmitted on the broadcast control channel at a lower repetition rate than that at which the system information messages are transmitted on the broadcast control channel.

64. An apparatus according to claim 63, wherein the messages that contain embedded information from application layer messages comprise an identifying portion formatted consistent with the system information messages and a payload portion including information from an application layer message.

65. An apparatus according to claim 63, wherein the means for creating and causing transmission of the messages that contain information from application layer messages comprises means for causing transmission of one message that contains information from an application layer message per an integer multiple of transmissions of the sequence of system information messages of the second class.

66. An apparatus according to claim 63, further comprising means for creating a schedule message that indicates a schedule for transmission of the messages that contain embedded information from application layer messages, and for causing transmission of the schedule message on the broadcast control channel.

67. An apparatus according to claim 66, wherein the means for creating and causing transmission of a schedule message comprises means for creating and causing transmission of a schedule message that indicates when a message including information from an application layer message of interest will be transmitted.

68. An apparatus according to claim 63, wherein the means for creating and causing transmission of system information messages and the means for creating and causing transmission of messages that contain embedded information from application layer messages comprise at least one of an Application Specific Integrated Circuit (ASIC) and a circuit module.

69. An apparatus for use in a General Packet Radio Service (GPRS) wireless mobile data communications system, the apparatus comprising:
means for receiving a sequence of Packet System Information (PSI) messages of the first class periodically transmitted on a Packet Broadcast Control Channel (PBCCH);
means for receiving PSI messages of a second class on the PBCCH transmitted in portions in successive intervals between transmissions of the sequence of PSI messages of the first class; and
means for receiving a PSI message of a third class on the PBCCH transmitted once per an integer multiple of transmissions of the sequence of PSI messages of the second class.

70. An apparatus according to claim 69, wherein the PSI messages of the third class comprise Extremely Low Repetition (ELR) Payload messages including embedded information from an application layer message.

71. An apparatus according to claim 69, further comprising means for receiving a schedule message on the PBCCH that indicates a schedule for transmission for PSI messages of the third class.

72. An apparatus according to claim 69, wherein the means for receiving a sequence of Packet System Information (PSI) messages of a first class, the means for receiving a sequence of PSI messages of a second class, and the means for receiving a PSI message of a third class comprises at least one of an Application Specific Integrated Circuit (ASIC) and a circuit module.

73. An apparatus, comprising:
means for receiving system information messages transmitted on a broadcast control channel of a wireless packet data communications system; and
means for receiving messages on the broadcast control channel that contain embedded information from application layer messages and that are transmitted at a lower repetition rate than that at which the system information messages are transmitted on the broadcast control channel.

74. An apparatus according to claim 73, wherein the messages that contain embedded information from application layer messages comprise an identifying portion formatted consistent with the system information messages and a payload portion including information from an application layer message.

75. An apparatus according to claim 73, wherein the means for receiving messages on the broadcast control channel that contain information from application layer messages comprises means for receiving one message that contains information from an application layer message per an integer multiple of transmissions of the sequence of system information messages of the second class.

76. An apparatus according to claim 73, further comprising means for receiving a schedule message that indicates a schedule for transmission of the messages that contain embedded information from application layer messages.

77. An apparatus according to claim 76, wherein the means for receiving a schedule message comprises means for receiving a schedule message that indicates when a message including information from an application layer message of interest will be transmitted.

78. An apparatus according to claim 73, wherein the means for receiving system information messages and the means for receiving messages on the broadcast control channel that contain embedded information from application layer messages comprise at least one of an Application Specific Integrated Circuit (ASIC) and a circuit module.

79. A computer program product comprising computer-readable program code embodied in a computer-readable program storage medium, the computer-readable program code comprising:
program code for causing periodic transmission of a sequence of Packet System Information (PSI) messages of a first class on a Packet Broadcast Control Channel (PBCCH) of a General Packet Radio Service (GPRS) wireless mobile data communications system;
means for causing transmission of successive portions of a sequence of PSI messages of a second class on the PBCCH in successive intervals between transmissions of the sequence of PSI messages of the first class; and
means for causing transmission of a PSI message of a third class on the PBCCH once per an integer multiple of transmissions of the sequence of PSI messages of the second class.

80. A computer program product according to claim 79, wherein the PSI messages of the third class comprise Extremely Low Repetition (ELR) Payload messages including embedded information from an application layer message.

81. A computer program product according to claim 79, further comprising program code for causing transmission of a schedule message on the PBCCH that indicates a schedule for transmission for PSI messages of the third class.

82. A computer program product comprising computer-readable program code embodied in a computer-readable program storage medium, the computer-readable program code comprising:
program code for causing repetitive transmission of system information messages on a broadcast control channel of a wireless packet data communications system; and
program code for causing transmission of messages on the broadcast control channel that contain embedded information from application layer messages at a lower repetition rate than that at which the system information messages are transmitted on the broadcast control channel.

83. A computer program product according to claim 82, wherein the messages that contain embedded information from application layer messages comprise an identifying portion formatted consistent with the system information messages and a payload portion including information from an application layer message.

84. A computer program product according to claim 82, further comprising program code for causing transmission of a schedule message that indicates a schedule for transmission of the messages that contain embedded information from application layer messages.

85. A computer program product comprising computer-readable program code embodied in a computer-readable program storage medium, the computer-readable program code comprising:
program code for receiving a sequence of Packet System Information (PSI) messages of a first class periodically transmitted on a Packet Broadcast Control Channel (PBCCH) of a General Packet Radio Service (GPRS) wireless mobile data communications system;
program code for receiving a sequence of PSI messages of a second class that are transmitted on the PBCCH that are transmitted in successive intervals between transmissions of the sequence of PSI messages of the first class; and
means for receiving a PSI message of a third class on the PBCCH that is transmitted once per an integer multiple of transmissions of the sequence of PSI messages of the second class.

86. A computer program product according to claim 85, wherein the PSI messages of the third class comprise Extremely Low Repetition (ELR) Payload messages including embedded information from an application layer message.

87. A computer program product according to claim 85, further comprising program code for receiving a schedule message on the PBCCH that indicates a schedule for transmission for PSI messages of the third class.

88. A computer program product comprising computer-readable program code embodied in a computer-readable program storage medium, the computer-readable program code comprising:
program code for receiving system information messages repetitively transmitted on a broadcast control channel of a wireless packet data communications system; and
program code for receiving messages on the broadcast control channel that contain embedded information from application layer messages and that are transmitted at a lower repetition rate than that at which the system information messages are transmitted on the broadcast control channel.

89. A computer program product according to claim 88, wherein the messages that contain embedded information from application layer messages comprise an identifying portion formatted consistent with the system information messages and a payload portion including information from an application layer message.

90. A computer program product according to claim 88, further comprising program code for receiving a schedule message that indicates a schedule for transmission of the messages that contain embedded information from application layer messages.
